(19) United States
(12) Patent Application Publication
(10) Pub. No.: US 2016/0187730 A1
(43) Pub. Date: Jun. 30, 2016

(54) Polymer Film With Geometrically Anisotropic Nanostructures

(71) Applicant: The Hong Kong University of Science and Technology, Hong Kong (CN)

(72) Inventors: Tao Du, Hong Kong (CN); Abhishek Kumar Srivastava, Hong Kong (CN); Valerii Vladimirovich Vashchenko, Hong Kong (CN); Vladimir Grigorievich Chigrinov, Hong Kong (CN); Hoi-Sing Kwok, Hong Kong (CN)

(21) Appl. No.: 14/951,897

(22) Filed: Nov. 25, 2015

Related U.S. Application Data
(60) Provisional application No. 62/177,080, filed on Mar. 6, 2015.
(60) Provisional application No. 62/123,750, filed on Nov. 26, 2014.

(51) Int. Cl. G02F 1/1337

(52) U.S. Cl. CPC G02F 1/133711; G02F 1/133788

(57) ABSTRACT

A polymer film with aligned geometrically anisotropic nanostructures includes: an alignment layer; and a mixture of liquid crystal polymer and geometrically anisotropic nanostructures. Methods for aligning geometrically anisotropic nanostructures and for optically manipulating geometrically anisotropic nanostructures are also provided.

### CROSS-REFERENCE TO RELATED APPLICATIONS

This patent application claims the benefit of U.S. Provisional Patent Application No. 61/123,750, filed Nov. 26, 2014, and U.S. Provisional Patent Application No. 62/177,080, filed Mar. 6, 2015, both of which are incorporated by reference herein.

### BACKGROUND

Geometrically anisotropic nanostructures like Quantum Rod (QR) and Carbon Nanotube (CNT) are materials that can exhibit anisotropic properties in the directions along and perpendicular to their long axes. In order to explore the anisotropic properties, bulk alignment of the geometrically anisotropic nanostructures is important.

Taking QR as an example, due to its geometrically anisotropic structure, a single QR nanocrystal emits linearly polarized light. However, in bulk, QRs are normally randomly distributed (non-polarized), due to the random distribution of the QRs in bulk. Thus, the light emission from bulk QRs shows no preferred polarization direction.

### SUMMARY

In an exemplary embodiment, the invention provides a polymer film with aligned geometrically anisotropic nanostructures, comprising: an alignment layer; and a mixture of liquid crystal polymer and geometrically anisotropic nanostructures.

In another exemplary embodiment, the invention provides a method for aligning geometrically anisotropic nanostructures, comprising: providing an alignment layer on a substrate; coating a mixture of liquid crystal polymer and geometrically anisotropic nanostructures onto the alignment layer; and polymerizing the liquid crystal polymers of the mixture to form a solid polymer network with aligned geometrically anisotropic nanostructures.

In another exemplary embodiment, the invention provides a method for optically manipulating geometrically anisotropic nanostructures, comprising: depositing a photoalignment material, anisotropic fluid and geometrically anisotropic nanostructures on a substrate; and irradiating the substrate with a polarized light source to expose the photoalignment material on the substrate.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 depicts an exemplary process flow for alignment of nanostructures.

FIG. 2 depicts the nano-scale alignment of a liquid crystal (LC) polymer film mixed with QRs.

FIG. 3 depicts an exemplary arrangement for testing the optical spectrum provided by a substrate having geometrically anisotropic nanostructures disposed thereon.

FIG. 4 depicts an optical spectrum of the laser of FIG. 3, which is used to illuminate the geometrically anisotropic nanostructures.

FIG. 5 depicts an optical spectrum of the emission light from the geometrically anisotropic nanostructures of FIG. 3.

FIG. 6 depicts the absorption and emission spectrum of an LC polymer film mixed with QRs according to an exemplary embodiment.

FIG. 7 depicts an exemplary process flow for in-situ control of the nanostructures orientation in an exemplary embodiment.

FIG. 8 depicts the absorption and emission spectra of an LC polymer layer mixed with QRs according to an exemplary embodiment.

FIG. 9 depicts an example of a glass substrate having QRs with two alignment domains according to an exemplary embodiment.

### DETAILED DESCRIPTION

Embodiments of the present invention utilize liquid crystal (LC) alignment technology to provide bulk alignment for geometrically anisotropic nanostructures. These embodiments achieve the advantages of reduced complexity for production and applications, and provide polymer films having advanced optical and electrical properties suitable for various applications. The anisotropic properties of the bulk alignments are advantageous, and, in particular, the polarized emission provided thereby is usable with respect to many photonic devices, including, for example, LCDs.

For example, with respect to QRs, to make sure the anisotropic emission of a single QR nanoparticle also applies in bulk, a certain extent of order in the QR nanoparticles distribution should be created. In other words, an alignment of the axes of the QRs is provided so that the bulk emission shows preferred polarization directions.

Polarized emission from QRs enhances the performance of many optical systems, for example, Liquid Crystal Displays (LCDs). LCDs normally operate with linearly polarized light, and conventional LCDs use a front polarizer to produce linearly polarized light from a non-polarized backlight. The polarization efficiency of the conventional front polarizer is normally lower than 50%, which means that more than 50% of the light energy will be lost before it passes through the liquid crystals of the LCD. However, by using aligned QRs as an LCD backlight, the polarized light emission from the QRs can pass through the front polarizer with little loss, and thus increase the brightness as well as the optical efficiency of the system.

Embodiments of the present invention utilize liquid crystal alignment technology to align nanostructures such as QR, CNT, and other geometrically anisotropic nanostructures. Exemplary embodiments of the present invention provide a method of aligning geometrically anisotropic nanostructures using LC alignment technology. The geometrically anisotropic nanostructures are mixed into LC polymers, which can be aligned by an LC alignment layer through surface interaction. The aligned LC polymers in turn align the geometrically anisotropic nanostructures to a preferred direction—e.g., either parallel or perpendicular to the common axis of the LC polymers. The long axes of the geometrically anisotropic nanostructures are thus aligned to a preferred common direction, which enhances the properties of the bulk material. After the alignment has been created, a further step of polymerization of the LC polymers may be provided to form a solid polymer network so that the alignment pattern of the nanostructures is fixed.

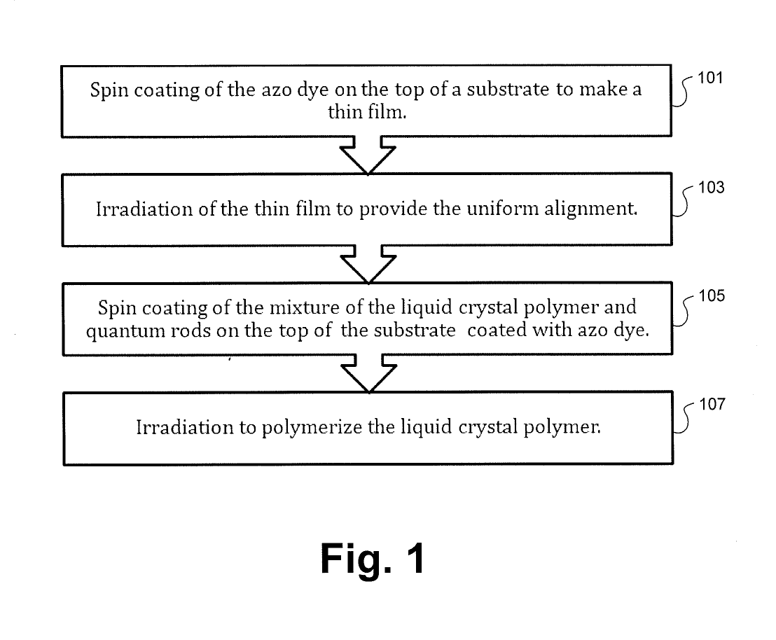

FIG. 1 depicts an exemplary process flow for alignment of nanostructures (e.g., QRs) in an exemplary embodiment. At stage 101, spin coating of an azo dye on top of a substrate is performed to form a thin film of azo dye on the substrate. At stage 103, the azo dye thin film is irradiated to provide a uniform alignment. At stage 105, a mixture of liquid crystal polymer and QRs is spin coated on top of the substrate having the coated/aligned azo dye. At stage 107, the coated mixture is irradiated to polymerize the liquid crystal polymer.

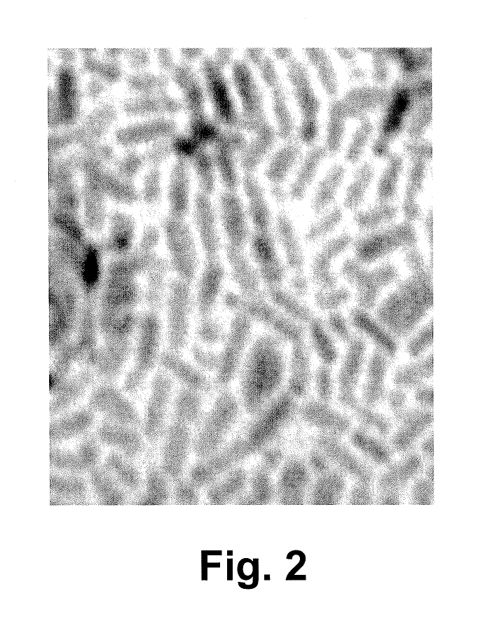

FIG. 2 depicts the nano-scale alignment of an LC polymer film mixed with QRs, produced according to an exemplary embodiment of the invention, with the long axes of the QRs exhibiting a preferred common direction. FIG. 2 is a TEM microphoto of the QR nanoparticles distributed in LC polymer networks, and it is visible that the QR nanoparticles exhibit preferred alignment directions.

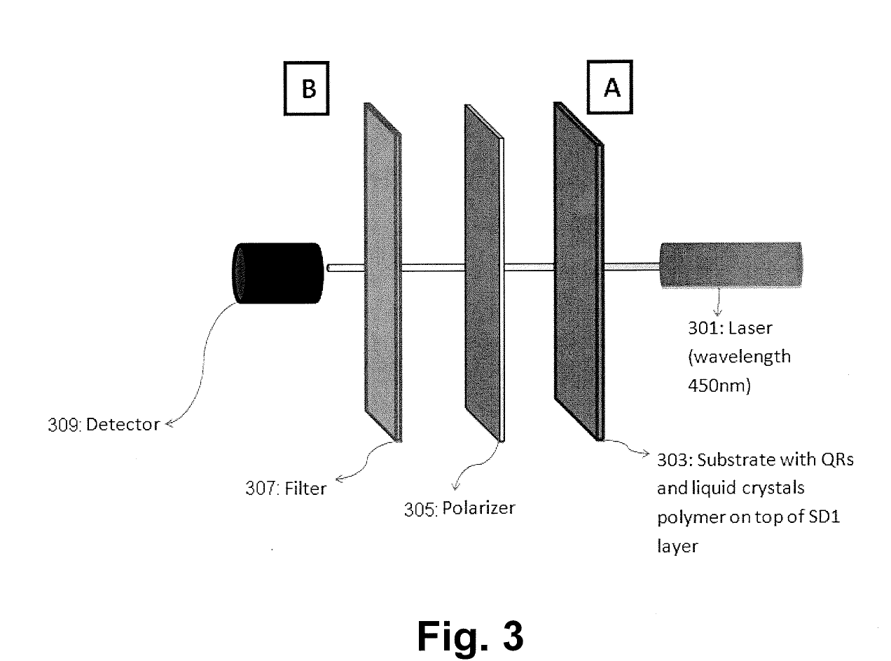

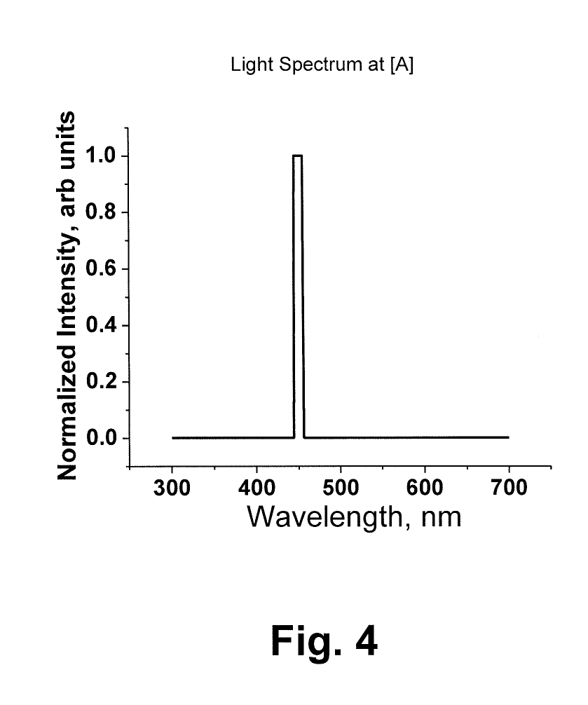

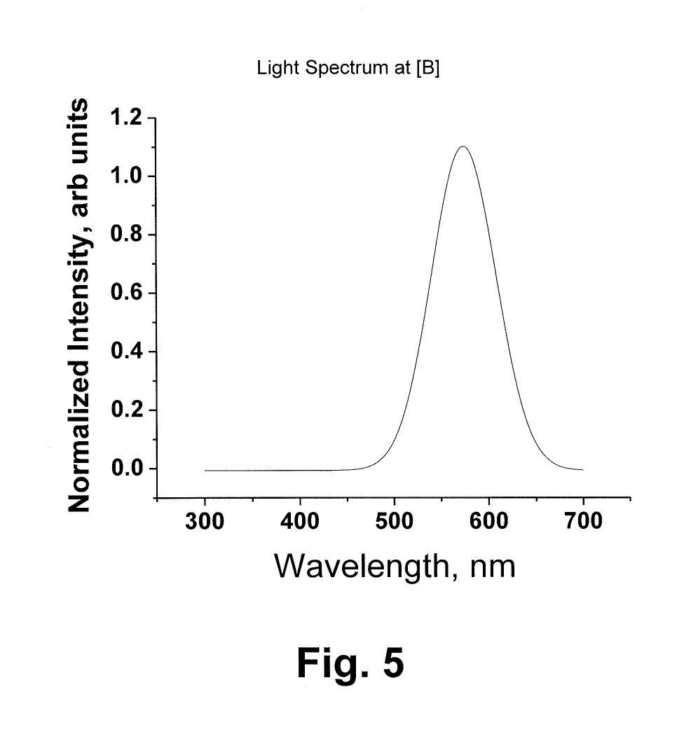

FIG. 3 depicts an exemplary arrangement for testing the optical spectrum provided by a substrate having geometrically anisotropic nanostructures (e.g., QRs) disposed thereon (e.g., a substrate with a mixture of QRs and liquid crystal polymers coated on top of an SD1 photoalignment layer). A laser 301 emits a beam with wavelength 450 nm, which passes through the substrate 303, a polarizer 305 and a filter 307. The resulting beam is detected by the detector 309. FIG. 4 depicts an optical spectrum of the laser (at point [A] in FIG. 3), which is used to illuminate the geometrically anisotropic nanostructures. FIG. 5 depicts an optical spectrum of the emission light from the geometrically anisotropic nanostructures (at point [B] in FIG. 3). From FIGS. 4 and 5, it can be seen that a polarized laser with central wavelength 450 nm was used to illuminate the aligned QRs substrate, and that the aligned QRs substrate, which absorbs the light, shows the polarized emission at 580 nm.

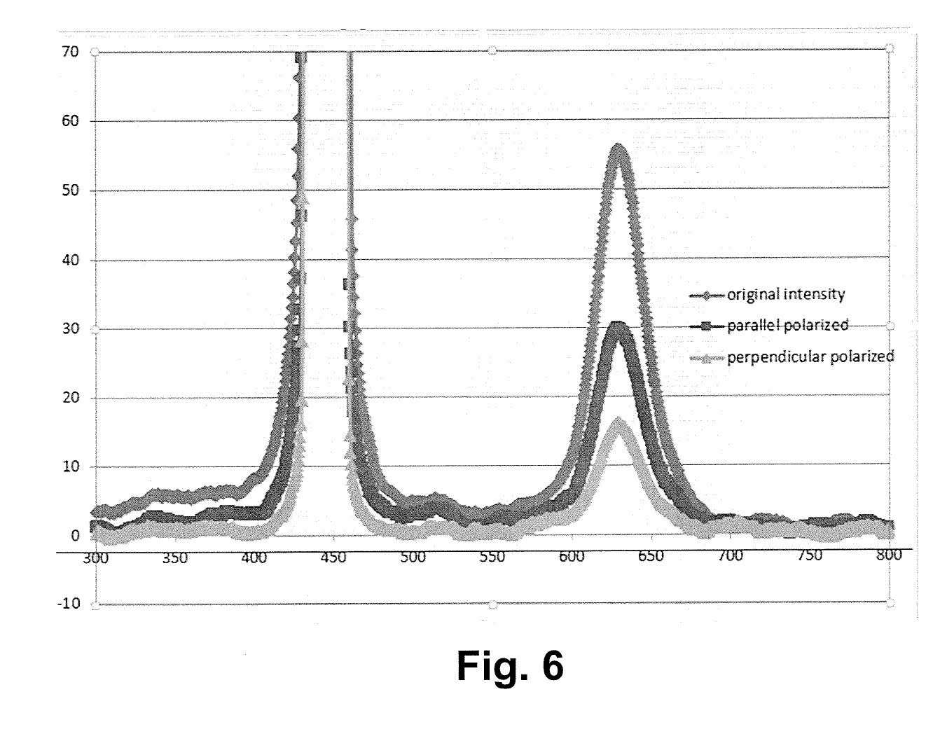

FIG. 6 shows the absorption and emission spectra of an LC polymer layer mixed with QRs according to an exemplary embodiment, wherein the emission spectra exhibit a preferred polarization state. The spectra shown in FIG. 6 demonstrate that the LC polymer film mixed with oriented QRs exhibits preferred linear polarization for emitted light. Specifically, it was confirmed that a certain extent of alignment of QR nanoparticles can be generated by mixing them into LC polymers and then aligning the mixture using an LC alignment layer. Polarized light emission with intensity ratio of around 2.5 has been achieved from the LC polymer film mixed with QRs, which could be further improved by selection and matching the chemical groups of both QRs and LC polymers, as well as by optimizing experimental conditions.

In an exemplary embodiment, the invention includes a polymer film with aligned geometrically anisotropic nanostructures, comprising: an alignment layer; and a mixture of liquid crystal polymer and geometrically anisotropic nanostructures.

In a further embodiment, the alignment layer is prepared by mechanical rubbing of polyimide materials or by photoalignment with a photosensitive layer. The alignment layer may also be prepared by oblique evaporation, by stretched polymer film, by surface stripped film, or by flow alignment.

In a further embodiment, the alignment layer comprises photo-sensitive sulfonic azo dye Tetrasodium5,5′-((1E,1′E)-(2,2′-disulfonato-[1,1′-biphenyl]-4,4′-diyl)bis(diazene-2,1-diyl))bis(2-hydroxybenzoate), configured to create an alignment direction after being irradiated by polarized light.

In a further embodiment, the liquid crystal polymer of the mixture is polymerized to form a solid polymer network.

In a further embodiment, the geometrically anisotropic nanostructures include QRs and/or CNTs. The geometrically anisotropic nanostructures may also include nano rods and/or geometrically anisotropic fluorescent dyes.

In an exemplary embodiment, the invention provides a method for aligning geometrically anisotropic nanostructures, comprising: providing an alignment layer on a substrate; coating a mixture of liquid crystal polymer and geometrically anisotropic nanostructures onto the alignment layer; and polymerizing the liquid crystal polymers of the mixture to form a solid polymer network with aligned geometrically anisotropic nanostructures.

In a further embodiment, the polymerized liquid crystal polymers serve as an alignment layer for an additional layer of liquid crystal polymers mixed with geometrically anisotropic nanostructures.

In a further embodiment, the additional layer of liquid crystal polymer mixed with geometrically anisotropic nanostructures is polymerized to form another solid polymer network with aligned geometrically anisotropic nanostructures.

In a further embodiment, the alignment layer is prepared with uniform alignment direction. The alignment layer may also be prepared with patterned alignment directions.

Embodiments of the present invention also provide for in-situ optical manipulations of local or bulk alignment of geometrically anisotropic nanostructures, which achieve advantages in flexibility. In particular, the local or bulk alignment of geometrically anisotropic nanostructures (which have been mixed into liquid crystal or liquid crystal polymer, aligned by an LC photoalignment layer such that the aligned liquid crystal or liquid crystal polymer in turn aligns the geometrically anisotropic nanostructures to a preferred direction, e.g., either parallel or perpendicular to the common axis of the liquid crystals) may be manipulated using a polarized light source with a certain wavelength band, such that the alignment direction of the nanostructures can be changed using light as many times as desired. Polymerization of liquid crystal polymers mixed with the geometrically anisotropic nanostructures allows the alignment to become fixed, such that the alignment direction of the nanostructures can no longer be changed.

In an exemplary embodiment, SD1 photoalignment material is used, which may be exposed by light between 300-480 nm (e.g., 450 nm) to write and rewrite the alignment of the photoalignment layer. A different wavelength of light (e.g., 360 nm) is used for polymerization.

Due to the effect of the liquid crystals or liquid crystal polymers aligning axes of the liquid crystals or liquid crystal polymers to preferred local alignment directions through surface interaction (and the liquid crystals or liquid crystal polymers in turn aligning the axes of the geometrically anisotropic nanostructures to preferred local alignment directions), in-situ manipulations of the alignment of geometrically anisotropic nanostructures is achieved in embodiments of the invention by in-situ manipulations of the alignment of the liquid crystal photoalignment layer.

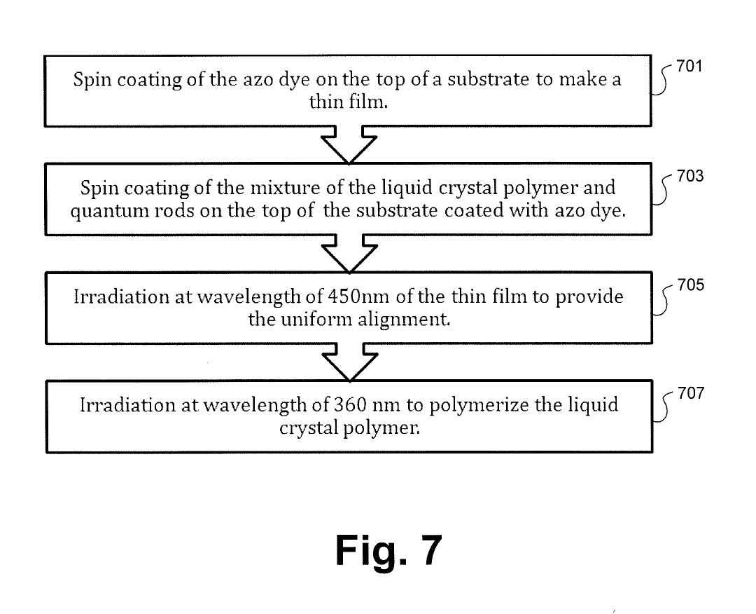

FIG. 7 depicts an exemplary process flow for in-situ control of the nanostructures orientation (followed by polymerization to fix the alignment) in an exemplary embodiment. At stage 701, an azo dye alignment layer is spin coated on a substrate to provide a thin film alignment layer on the substrate. At stage 703, a mixture of liquid crystal polymer and nanostructures (e.g., quantum rods) is spin coated onto the substrate coated with azo dye. At stage 705, irradiation, for example at a wavelength of 450 nm, is provided to align the alignment layer (which in turn provides alignment for the nanostructures). At stage 707, irradiation is provided at a different wavelength, for example at a wavelength of 360 nm, to polymerize the liquid crystal polymer. It will be appreciated that, before the polymerization of stage 707, the alignment step of stage 705 may be repeated multiple times to write and rewrite the alignment of the alignment layer and nanostructures in different ways.

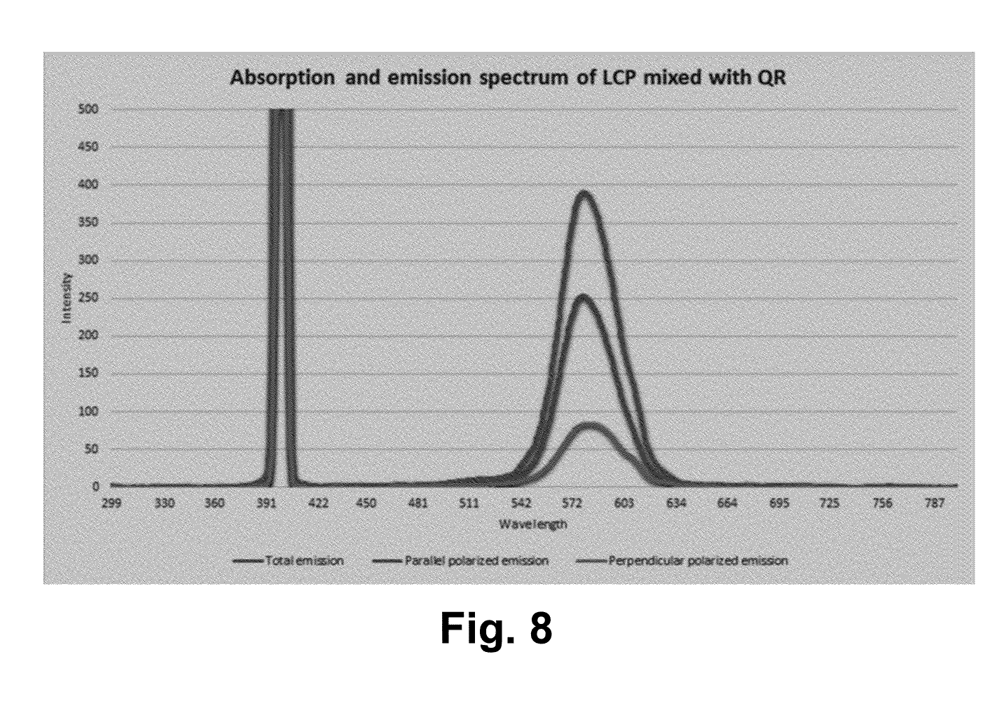

FIG. 8 depicts the absorption and emission spectra of a LC polymer layer mixed with QRs according to an exemplary embodiment, wherein the emission spectra exhibit a preferred polarization state.

In an exemplary embodiment corresponding to FIG. 7, continuous rotation of QRs was achieved using a laser with rotating polarization directions (at stage 705).

It will be appreciated that the exemplary embodiment depicted in FIG. 1 corresponds to a “pre-alignment” process, where the alignment film is first coated onto the substrate and irradiated to provide alignment, after which the liquid crystal polymer and nanostructures are added. The exemplary embodiment depicted in FIG. 7, on the other hand, corresponds to a process where the alignment is provided via irradiation after the alignment layer, liquid crystal polymer and nanostructures are present.

In an exemplary embodiment a method for optically manipulating geometrically anisotropic nanostructures, comprising: depositing a photoalignment material on a substrate; depositing a mixture of anisotropic fluid (e.g., liquid crystals or liquid crystal polymers) and geometrically anisotropic nanostructures on the substrate having the photoalignment material deposited thereon; and irradiating the substrate with a polarized light source within a wavelength band (e.g., 450 nm) to expose the photoalignment material on the substrate. Alternatively, the photoalignment material, anisotropic fluid, and geometrically anisotropic nanostructures may be combined and coated onto the substrate as a single mixture, or may be coated onto the substrate in three stacked layers.

In a further embodiment, the photoalignment material is made of photo-sensitive material which interacts with the polarized light source of a certain wavelength or wavelength band to align the anisotropic fluid (e.g., liquid crystal materials) based on the polarization direction and intensity of the polarized light source, and the alignment pattern of the anisotropic fluid is induced by the alignment pattern of the photoalignment material and the alignment pattern of the geometrically anisotropic nanostructures is induced by the alignment pattern of the anisotropic fluid. The photoalignment material may be azo-dye.

In a further embodiment, a combination of the photoalignment materials, anisotropic fluid and geometrically anisotropic nanostructures provides aligned nanostructures after being exposed to the polarized light source

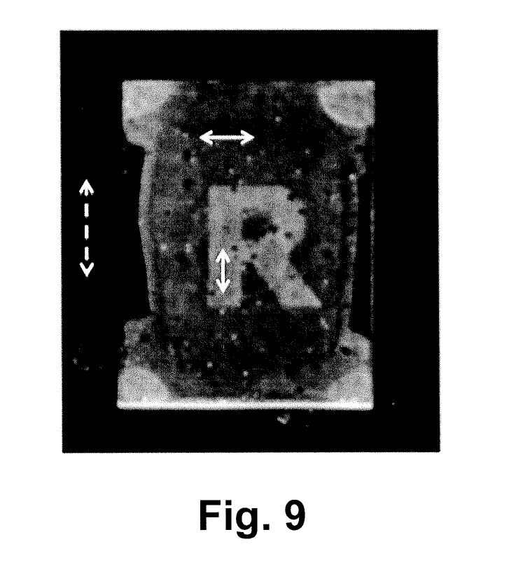

In a further embodiment, multiple domains having distinct alignment directions are provided by the irradiating. For example, a multi-step alignment procedure with an amplitude mask is used to create two different easy axes in the adjacent domains on the SD1 alignment layer after defining the alignment domains of the mixture of liquid crystal polymer and QRs on the alignment layer with two alignment domains. FIG. 9 depicts an example of a glass substrate having QRs with two alignment domains in an exemplary embodiment, in the form of the letter “R.” The solid arrows show the alignments of the QR, while the dotted arrow shows the substrate with two domains having easy axes mutually orthogonal to each other. On being illuminated by the polarized light, the two domains show clear contrast.

In a further embodiment, additional layers (comprising photoalignment material, anisotropic fluid, and/or nanostructures) are deposited to form a multi-layer structure.

In a further embodiment, the photoalignment material is azo-dye, and irradiation of the azo-dye to the polarized light source causes an alignment of the azo-dye to be rewritten from a previous local alignment direction to a new local direction based on the polarization direction and intensity of the said polarized light source.

In a further embodiment, the geometrically anisotropic nanostructures are synthesized with certain types of ligands to make alignment of the nanostructures with respect to the alignment of liquid crystalline molecules surrounding them.

In a further embodiment, the geometrically anisotropic nanostructures include nano rods, QRs, nano wires, CNTs, iodine, and/or geometrically anisotropic fluorescent dyes.

In a further embodiment, the photoalignment material is exposed by the polarized light source to manipulate its alignment (and the alignment of the geometrically anisotropic nanostructures) in a spatial and temporal manner (i.e., based on the spatial distribution of the intensity on the substrate plane and based on the temporal distribution of the light) depending on the spatial and temporal polarization direction and intensity of the said polarized light source.

In a further embodiment, the anisotropic fluid includes liquid crystal polymers, which are then polymerized to make a solid film to fix the alignment patterns of the geometrically anisotropic nanostructures mixed with the anisotropic fluid.

Additional details regarding exemplary embodiments may be found, for example, in T. Du, J. Schneider, A. K. Srivastava, A. S. Susha, V. G. Chigrinov, H. S. Kwok and A. L. Rogach, “Combination of Photo-Induced Alignment and Self-Assembly to Realize Polarized Emission from Ordered Semiconductor Nanorods”, ACS Nano (Oct. 15, 2015), which is incorporated herein by reference in its entirety. This paper discloses, for example, a process of aligning nanostructures based on the photoalignment of SD1 azo dye and combines photo-induced alignment with the self-assembly of nano rods. With this approach, the alignment directions of highly emissive semiconductor nano rods in both microscopic and macroscopic scale can be defined with the order parameter as high as 0.87. As a result, polarized emission has been achieved with the degree of polarization of 0.62. Furthermore, patterned alignment of nano rods with spatially varying local orientations has been realized to demonstrate the great flexibility of this approach.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A polymer film with aligned geometrically anisotropic nanostructures, comprising:
an alignment layer; and
a mixture of liquid crystal polymer and geometrically anisotropic nanostructures.

2. The polymer film according to claim 1, wherein the alignment layer is prepared by mechanical rubbing of polyimide materials or by photoalignment with a photosensitive layer.

3. The polymer film according to claim 1, wherein the alignment layer comprises photo-sensitive sulfonic azo dye Tetrasodium5,5′-((1E,1′E)-(2,2′-disulfonato-[1,1′-biphenyl]-4,4′-diyl)bis(diazene-2,1-diyl))bis(2-hydroxybenzoate), configured to create an alignment direction after being irradiated by polarized light.

4. The polymer film according to claim 1, wherein the liquid crystal polymer of the mixture is polymerized to form a solid polymer network.

5. A method for aligning geometrically anisotropic nanostructures, comprising:
providing an alignment layer on a substrate;
coating a mixture of liquid crystal polymer and geometrically anisotropic nanostructures onto the alignment layer; and
polymerizing the liquid crystal polymers of the mixture to form a solid polymer network with aligned geometrically anisotropic nanostructures.

6. The method according to claim 5, wherein the polymerized liquid crystal polymers serve as an alignment layer for an additional layer of liquid crystal polymers mixed with geometrically anisotropic nanostructures.

7. The method according to claim 6, wherein the additional layer of liquid crystal polymer mixed with geometrically anisotropic nanostructures is polymerized to form another solid polymer network with aligned geometrically anisotropic nanostructures.

8. A method for optically manipulating geometrically anisotropic nanostructures, comprising:
depositing a photoalignment material, anisotropic fluid and geometrically anisotropic nanostructures on a substrate; and
irradiating the substrate with a polarized light source to expose the photoalignment material on the substrate.

9. The method according to claim 8, wherein the depositing further comprises:
depositing the photoalignment material on the substrate; and
depositing a mixture of the anisotropic fluid and the geometrically anisotropic nanostructures on the substrate having the photoalignment material deposited thereon.

10. The method according to claim 8, wherein the depositing further comprises:
depositing a mixture of the photoalignment material, the anisotropic fluid and the geometrically anisotropic nanostructures on the substrate.

11. The method according to claim 8, wherein the photoalignment material, the anisotropic fluid and the geometrically anisotropic nanostructures are deposited on the substrate as separate stacked layers.

12. The method according to claim 8, wherein a combination of the photoalignment materials, anisotropic fluid and geometrically anisotropic nanostructures provides aligned nanostructure after being exposed to the polarized light source.

13. The method according to claim 8, wherein multiple domains having distinct alignment directions are provided by the irradiating.

14. The method according to claim 8, wherein additional layers are deposited to form a multi-layer structure.

15. The method according to claim 8, wherein the anisotropic fluid comprises liquid crystals or liquid crystal polymers.

16. The method according to claim 8, wherein the photoalignment layer is made of photo-sensitive material, configured to interact with the polarized light source to provide for alignment of the anisotropic fluid.

17. The method according to claim 8, wherein an alignment pattern for the anisotropic fluid is induced by an alignment pattern of the photoalignment material.

18. The method according to claim 8, wherein an alignment pattern of the geometrically anisotropic nanostructures is induced by an alignment pattern of the anisotropic fluid.

19. The method according to claim 8, wherein the photoalignment material is azo-dye, and wherein irradiation of the azo-dye to the polarized light source causes an alignment of the azo-dye to be rewritten from a previous local alignment direction to a new local direction based on the polarization direction and intensity of the said polarized light source.

20. The method according to claim 16, wherein the azo-dye is irradiated in a spatial and temporal manner based on the spatial and temporal polarization direction and intensity of the polarized light source.

21. The method according to claim 8, wherein the geometrically anisotropic nanostructures include nano rods, quantum rods (QRs), nano wires, and/or carbon nanotubes (CNTs).

22. The method according to claim 8, wherein the geometrically anisotropic nanostructures include iodine or fluorescent dyes.
